(19) United States
(12) Patent Application Publication
(10) Pub. No.: US 2005/0265902 A1
(43) Pub. Date: Dec. 1, 2005

(54) Industry standard multi-well plates with increased capacity and efficiency per well

(76) Inventors: Ellen Chen, Patchogue, NY (US); Wei He, South Setauket, NY (US); Wei Weng, Patchogue, NY (US)

Correspondence Address: Rashida A. Karmali;13th Floor, 99 Wall Street, New York, NY, 10005, US

(21) Appl. No.: 10/855,073

(22) Filed: May 27, 2004

(51) Int. Cl. B01L 9/00

(52) U.S. Cl. 422/104

(57) ABSTRACT

The invention provides for improved multi-well plates and platforms that comprise a plurality of wells having increased volume capacity and clustered in a standard multi-well plate format and dimensions, said multi-well plate format being compatible with auxiliary equipment currently used and designed for the particular multi-well plate format. More particularly, the invention provides improved multi-well plates comprising a base to improve wells having one or more said wells having rectangular configuration, better retention of working materials and tissue culture ingredients than observed in conventional round-shaped wells. A cover is provided for protecting the assembly and cell cultures.

### BACKGROUND TO THE INVENTION

This invention relates to improved tissue culture plates having a plurality of wells or chambers, and more particularly to such wells or chambers rectangular in shape, and having an increased volume capacity, while meeting the industry dimensional standards for multi-well plate formats.

Multi-well plates are used in a variety of assays using media, test ingredients and cells or tissues to study cell growth, carry out virus isolations and titrations, and toxicity tests, to name a few assays. Such multi-well plates are illustrated in U.S. Pat. Nos. 4,734,192, 5,009,780, 5,141,719, for example.

The Society for Biolmolecular Screening (SBS) has published certain dimensional standards for multi-well plates and microplates in response to non-uniform commercial products. This is because the dimensions of multi-well plates produced by different vendors varied, causing numerous problems when multi-well plates are to be used in automated laboratory instrumentation. The SBS standards address these variances by providing dimensional limits for multi-well plates intended for automation. Industry standard multi-well plates are laid out with 96 wells in an 8×12 matrix having 8 rows of 12 wells. The height, length and width of the 96 well plates are standardized. This standardization has led to the development of a variety of auxiliary equipment specifically developed for 96-well formats. The equipments include devices that load and unload precise volumes of liquid in multiples of 8, 12 or 96 at a time. This equipment transfers liquid to and from the wells, transmits light through the wells, reads calorimetric changes or chemiluminescence in individual wells, and many other functions. Some of this equipment is automated and instrumented to record, analyze and process data. In other words, this equipment is expensive to change or replace if the SBC standards are not complied with.

Typically, a 96-well plate is used to conduct multiple arrays or purifications or titrations simultaneously. For example, a membrane may be placed on the bottom of each of the wells. The membrane has specific properties selected to separate different molecules by filtration or to support biological or chemical reactions. High throughput applications, such as DNA sequences, PC R product cleanup, plasmid preparation, drug screening, sample binding and sample elution require products that perform consistently and effectively using automated laboratory instrumentation. However, the standard 96-well plate provides wells having a relatively small surface area (0.35 cm²), thereby requiring growing cells in a large number of 96-well microplates to obtain sufficient amounts for DNA extraction. Other disadvantages and problems encountered when using 96-well plates include: labor intensive, time-consuming and costly procedures involving frequent changes of culture medium to avoid cell death, cells overgrowing in the limited surface area of the micro-wells and repeated changes of media leading to contamination.

It would therefore be desirable to provide a multi-well plate format that is in compliance with the SBS standards, yet maximizes well volume and is compatible with automated robotics equipment such as liquid handlers, stackers, grippers and barcode readers.

It also would be desirable to provide a multi-well plate format that includes a plurality of wells of varying sizes, configured within the SBS standards, having a larger volume capacity than the circular microwell in the 96-well plate.

It would be desirable to provide a multi-well plate format that is in compliance with the SBS standards, having wells that are rectangular in shape and having walls that allow improved retention of ingredients added to the cultures and allowing convenient format for plate processing such as pipetting, washing, shaking, detecting, storing, etc.

It would be desirable to adapt the present invention to accommodate a culture insert; or a membrane to enable translation and permeation studies. This invention also relates to a multi-well plate useful for procedures in growing cells, or tissue culture in vitro and more particularly for supporting or positioning cell culture inserts that are used in the procedure. Devices described in U.S. Pat. Nos. 4,495,289, 5,026,649, 5,358,871 and 5,962,250 comprise wells having a circular shape and size which permit introduction of a cell culture insert having a membrane and a means for supporting the cell culture insert. These references are incorporated in their entirely herein, to be adapted to the rectangular shaped wells structured in multi-well plates conforming to the 96-well SBS standard.

### SUMMARY OF THE INVENTION

The problems of the prior art have been overcome be the present invention, which provides an improved industry standard multi-well plate designed to be compatible with auxiliary equipment and automated instrumentation for a multi-well plate format that includes a plate or tray having a plurality of wells, wherein said wells are rectangular in shape and have an increased volume capacity than the conventional 96-well plate round well. The plate is a one piece design having 48, 32, 24, 16, 12 or 8 rectangular wells to replace the 96 wells with the surface area approximately of 1.1 cm², 1.7 cm², 2.3 cm², 3.6 cm², 4.9 cm², or 7.4 cm² respectively, in order to increase the volume capacity to allow more cells to grow per well. Thus, the design maximizes the well volume and surface area of the well while remaining in compliance with the SBS format for the 96-well plate.

In one exemplary aspect, the multi-well plate format of the present invention provides at least one membrane which is insertable into a well to divide the well into separate membranes. The membrane fits snugly between the walls of the rectangular well either vertically or horizontally and the membrane is removable from the well to allow cells to be grown on the membrane before insertion into the well. The membrane may optionally have a frame to hold it rigidly. The membrane may be oriented to allow cells to be seeded on it and then inserted into the well to carry out transportation or permeation tests, in order to simulate the transport of various substances through cell layers, selected from cells including cells lining the human intestine, blood vessels and epithelial cells.

In still a further aspect the multi-well plate format of the present invention may be modified to accommodate a cell culture insert by including wells having a raised mouth surface. For examples, the multi-well plate includes an upper surface, a lower surface, and a plurality of wells, wherein each of said wells is substantially disposed between the upper and lower surface of the test plate. Each well comprises a sidewall, a bottom surface and a raised mouth surface raised from the upper surface. Each well has a cover having a top closure wall, said cover being adapted to be supported in a closed position with the closure wall adjacent the top edges of the wells.

This invention still further provides an exemplary method for performing assays in increased capacities. According to the method, cells are grown in larger numbers in rectangular wells having enlarged volume capacity. The walls of the rectangular wells allow improved retention of ingredients and materials than those of the round wells. The method is further adapted to include a membrane that is inserted into a well to divide the well, to carry out diffusion, transportation and permeation studies of substances comprising of biologics or chemicals.

### BRIEF DESCRIPTION OF FIGURES

FIG. 1 shows the top and side views of a prior art 96-well plate with its wells and overall dimensions conforming to the standardized format adopted by the SBS.

FIG. 2 shows the top and side views of a prior art 48-well plate. The well capacity is larger than the 96-well plate but does not conform to the standard 96-well plate format.

FIG. 3 shows the top and side views of a prior art 24-well plate. The well capacity is larger then the 96-well plate but does not conform to the standard 96-well plate format.

FIG. 4 shows the top and side views of a new multi-well plate in 8×1 (rows×well) matrix with a total of 8 wells.

FIG. 5 shows the top and side views of a new multi-well plate in 8×2 matrix with a total of 16 wells.

FIG. 6 shows the top and side views of a new multi-well plate in 8×3 matrix with a total of 24 wells.

FIG. 7 shows the top and side views of a new multi-well plate in 8×4 matrix with a total of 32 wells.

FIG. 8 shows the top and side views of a new multi-well plate in 8×6 matrix with a total of 48 wells.

FIG. 9 shows the top and side views of a new multi-well plate in 1×12 matrix with a total of 12 wells.

FIG. 10 shows the top and side views of a new multi-well plate in 2×12 matrix with a total of 24 wells.

FIG. 11 shows the top and side views of a new multi-well plate in 4×12 matrix with a total of 48 wells.

### DETAILED DESCRIPTION OF THE PREFERRED EMBODIMENTS

The invention provides an improved industry standard multi-well plate that is designed to be compatible with auxiliary equipment and automated instruments currently in use.

According to the invention the multi-well plate includes a plate or tray having a plurality of wells, wherein said wells are rectangular in shape and have a larger volume and surface area than the conventional 96-well plate well. Exemplary plate formats which may be used with multi-well plates with the invention comprise conventionally formatted multi-well plates, including 96-well plates, 384-well plates, and the like. Such multi-well plates may be adapted to include 48, 32, 24, 16, 12 or 8 rectangular wells in the SBS configuration of a 96-well plate as described in greater detail hereinafter. Configuration of the multi-well plates of the invention as described herein is particularly advantageous in that it allows use of rectangular wells having a larger volume and surface area to accommodate efficient growth of mammalian based cells. It may also be modified to have the upper surface of the well walls include a raised mouth surface to prevent contamination between wells.

Exemplary embodiments of the present invention include adaptations to accommodate a culture insert or a membrane to enable transportation, diffusion and permeation studies.

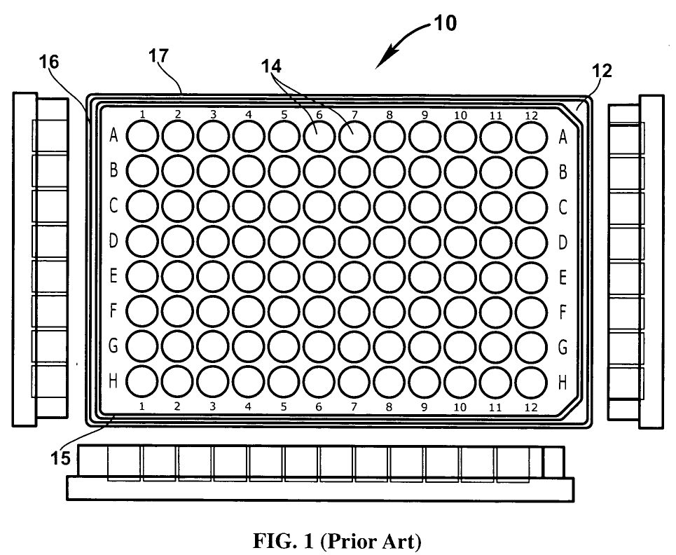

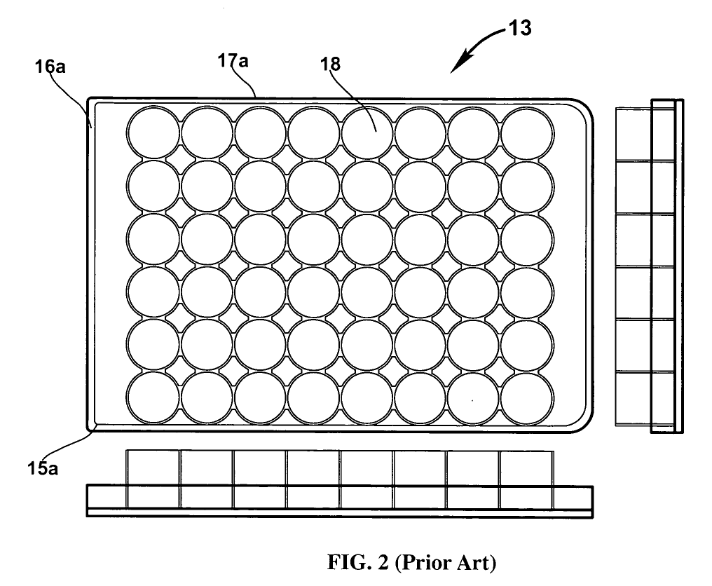

Referring now to FIGS. 1-2, two embodiments of multi-well plates used in prior art will be described.

FIG. 1 describes a standard 96-well plate 10 comprising a plate 12 having a plurality of wells 14. As shown, plate 12 includes 96 wells, and the wells are organized into a two-dimensional array as shown. The standardized height (15), width (16) and length (17) of plate 12, are 1.42 cm, 8.55 cm and 12.78 cm respectively. An array of wells (14) arranged in a 8×12 matrix representing 8 rows of 12 wells each, provides 96 identical wells in the plate 12. Each well 14 has a surface area of 0.35 cm².

The SBS standardization of the 96-well plate format has led to the development of equipment in the industry to be designed specifically for the 96-well plate format. Such auxiliary equipment includes robotic and automated instrumentation to program fro recording, analyzing, and manipulating data.

FIG. 2 shows an example of a standard 48-well plate 13. The plate 13 includes 48 wells 18, each of said wells 18 having a size almost three times larger than the well 14 in a 96-well plate 12. The surface area of each well 18 is 1.0 cm². An array of wells 18 arranged in a 6×8 matrix representing 6 rows of 8 wells each, provides 48 identical wells 18 in plate 13. This configuration of this plate 13 (height 15a, width 16a, and length 17a) does not, however, confirm to the configuration of the standard 96-well plate 12. Thus, the plate 13 is not compatible with the auxiliary equipment or multichannel pipetting equipment designed for the 96-well format. Therefore, most of the liquid handling and processing with the 48-well plates 13 has to be hand-operated, one sample at a time. This is time consuming, inconvenient and expensive.

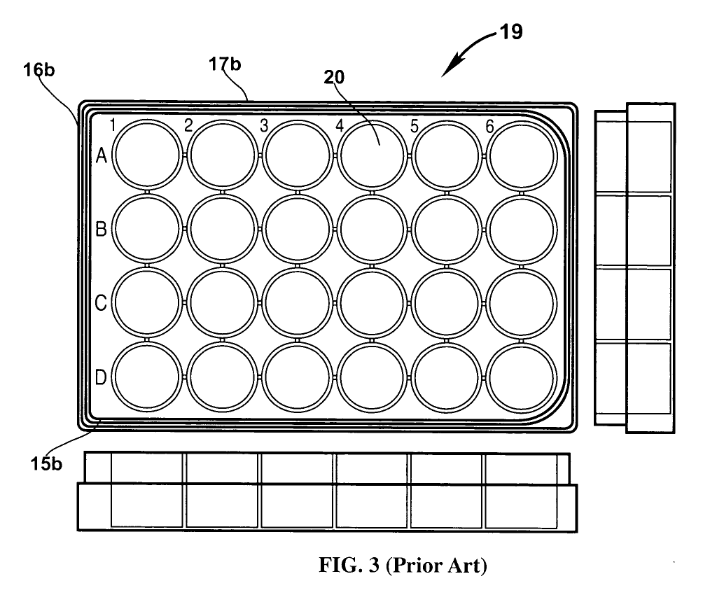

FIG. 3 describes a standard 24-well plate 19, including 24 wells 20, each of said wells 20 having a size almost two times and six times larger than the well 18 in plate 13 and well 20 in plate 19, respectively. The 24-well plate 19 has a height 15b, width 16b, and length 17b that does not either conform to the SBS standard of a 96-well plate 12 and is therefore not compatible with the auxiliary equipment or multi-channel pipettes designed for the 96-well format 12. Most of the liquid addition and removal is therefore hand-operated one sample at a time, and is therefore a great disadvantage.

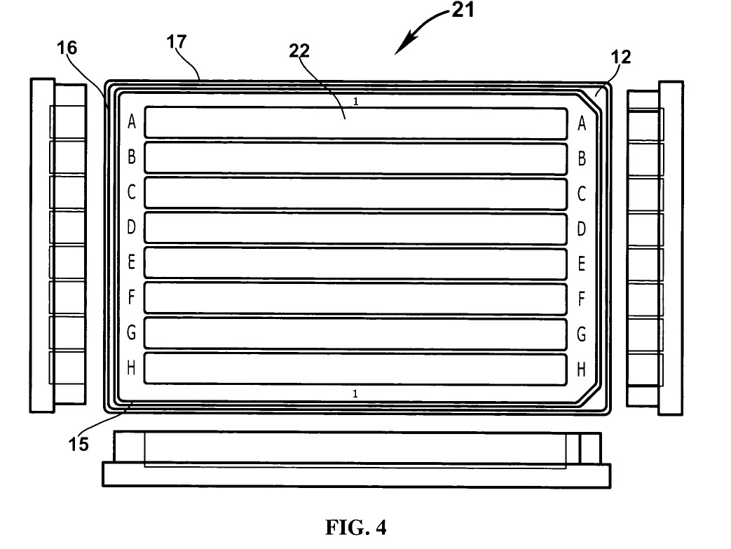

A preferred embodiment of the test plate 21 of this invention, shown in FIG. 4, includes a base 12, and a plurality of wells 22. This novel design of a multi-well plate includes 8 wells 22 arranged in a 8×1 matrix, having a configuration that conforms to the SBS standard of the 96-well plate (same height 15, width 15, and length 17) and is therefore compatible with auxiliary equipment, automated instrumentation and robotics, all designed for the 96-well format. Importantly, the size of the well 22 is approximately nineteen (19) times larger than the well 14 in the 96-well plate. Therefore, in an exemplary method for performing an assay, the amount of liquid that would be added in well 22 would be approximately nineteen (19) times the volume (v) or surface area of that would be added in the well 14 of the 96-well plate 10. This could be done using one dispenser (10 v), 2 dispensers (5 v), 5 dispensers (2 v) or 10 dispensers (1 v). Preferably, this is done using the auxiliary equipment used in the industry.

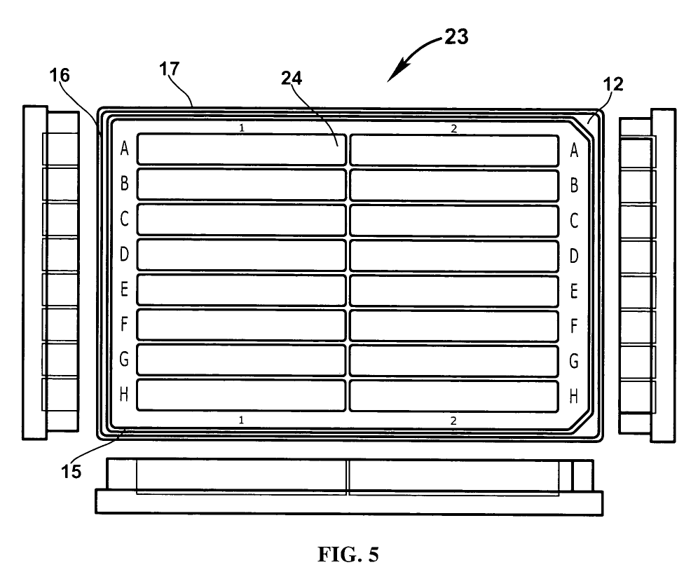

Referring to FIG. 5, an alternative embodiment of the multi-well plate 23 will be described. The test plates include a base 12, and a plurality of wells 24. This novel design includes 16 wells 24 arranged in a 8×2 matrix, and having a configuration that conforms to the SBC standard of a 96-well plate (same height 15, width 15, and length 17) thereby being compatible with auxiliary equipment, automated instrumentation and robotics available in the industry. In this embodiment, the well 24 size is approximately nine (9) times larger than the well 14 in the 96-well plate 10.

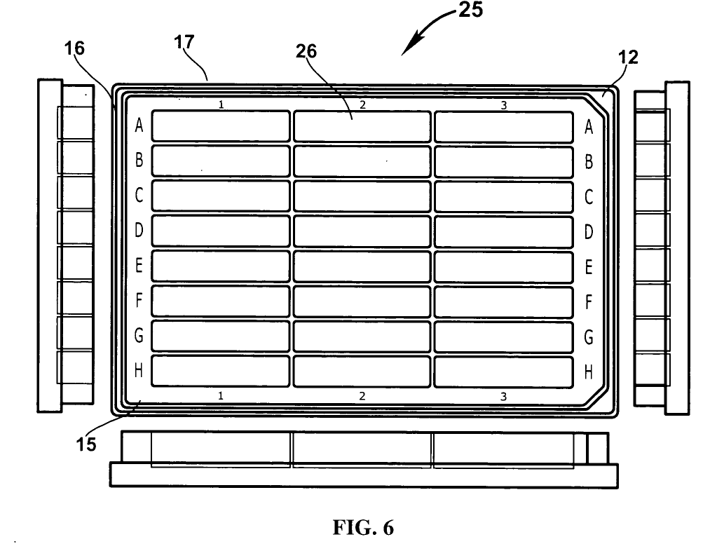

Referring to FIG. 6, another embodiment of the multi-well plate 25 will be described. The test plate 25 includes a base 12, and a plurality of wells 26. The novel design includes 24 wells 26 arranged in a 8×3 matrix, and having a configuration that conforms to the SBC standard for a 96-well plate (same height 15, width 15, and length 17) thereby being compatible with auxiliary equipment, automated instrumentation and robotics available in industry. In this embodiment, the well 26 size is approximately (6) times larger than the well 14 in the 96-well plate 10.

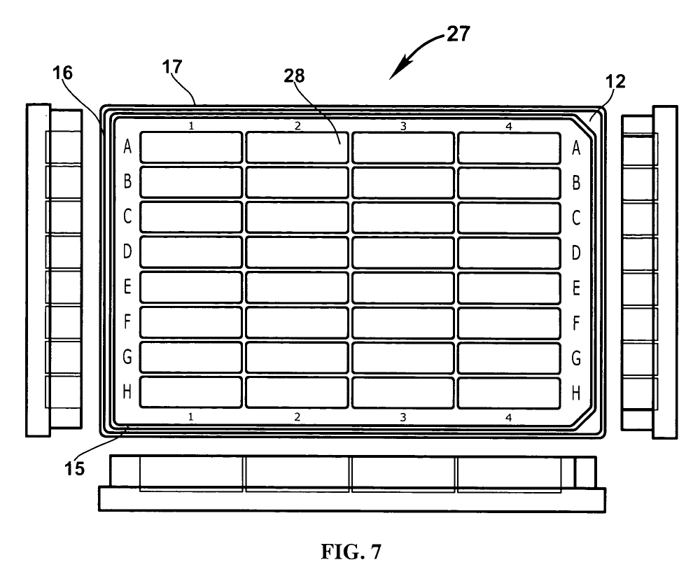

Referring to FIG. 7, another embodiment of the multi-well plate 27 will be described. The test plate 27 includes a base 12, and a plurality of wells 28. The novel design includes 32 wells 28 arranged in a 8×4 matrix, and having a configuration that conforms to the SBC standard for a 96-well plate (same height 15, width 15, and length 17) thereby being compatible with auxiliary equipment, automated instrumentation and robotics available in industry. In this embodiment, the well 28 size is approximately (4) times larger than the well 14 in the 96-well plate 10.

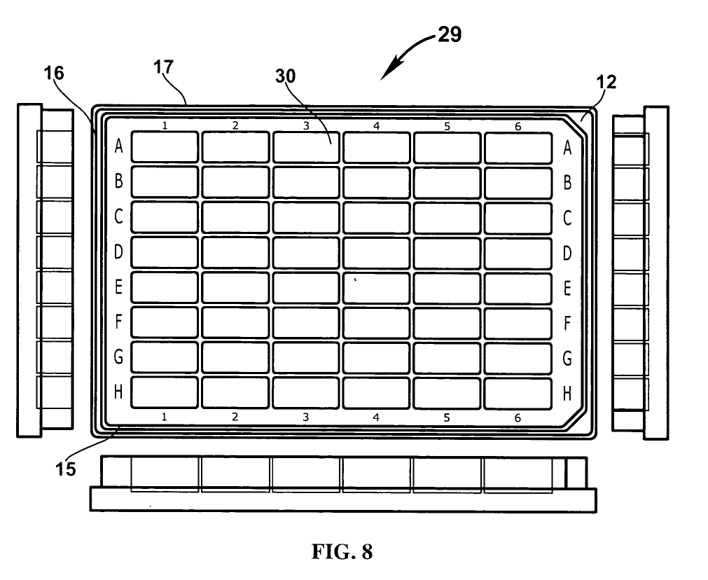

Referring to FIG. 8, another embodiment of the multi-well plate 29 will be described. The test plate 29 includes a base 12, and a plurality of wells 30. The novel design includes 48 wells 30 arranged in a 8×6 matrix, and having a configuration that conforms to the SBC standard for a 96-well plate (same height 15, width 15, and length 17) thereby being compatible with auxiliary equipment, automated instrumentation and robotics available in industry. In this embodiment, the well 30 size is approximately three (3) times larger than the well 14 in the 96-well plate 10.

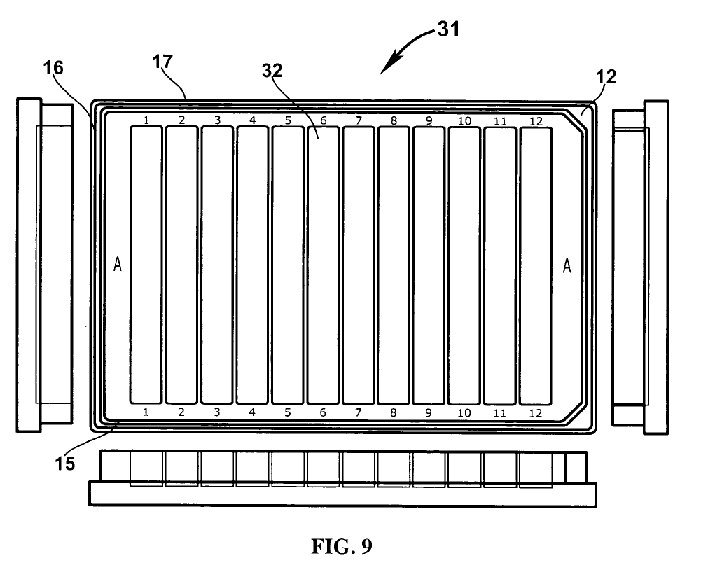

Referring to FIG. 9, another embodiment of the multi-well plate 31 will be described. The test plate 31 includes a base 12, and a plurality of wells 32. The novel design includes 12 wells 32 arranged in a 1×12 matrix, and having a configuration that conforms to the SBC standard for a 96-well plate (same height 15, width 15, and length 17) thereby being compatible with auxiliary equipment, automated instrumentation and robotics available in industry. In this embodiment, the well 32 size is approximately thirteen (13) times larger than the well 14 in the 96-well plate 10.

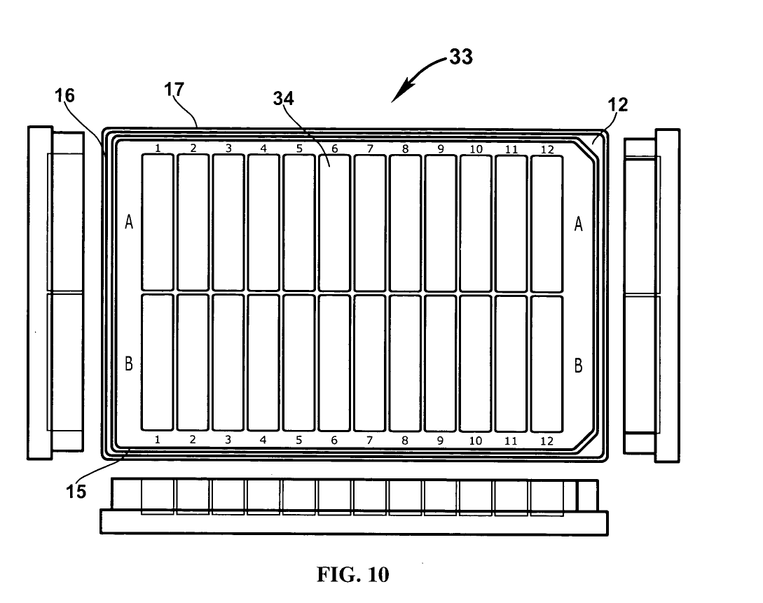

Referring to FIG. 10, another embodiment of the multi-well plate 33 will be described. The test plate 33 includes a base 12, and a plurality of wells 34. The novel design includes 12 wells 34 arranged in a 2×12 matrix, and having a configuration that conforms to the SBC standard for a 96-well plate (same height 15, width 15, and length 17) thereby being compatible with auxiliary equipment, automated instrumentation and robotics available in industry. In this embodiment, the well 34 size is approximately six (6) times larger than the well 14 in the 96-well plate 10.

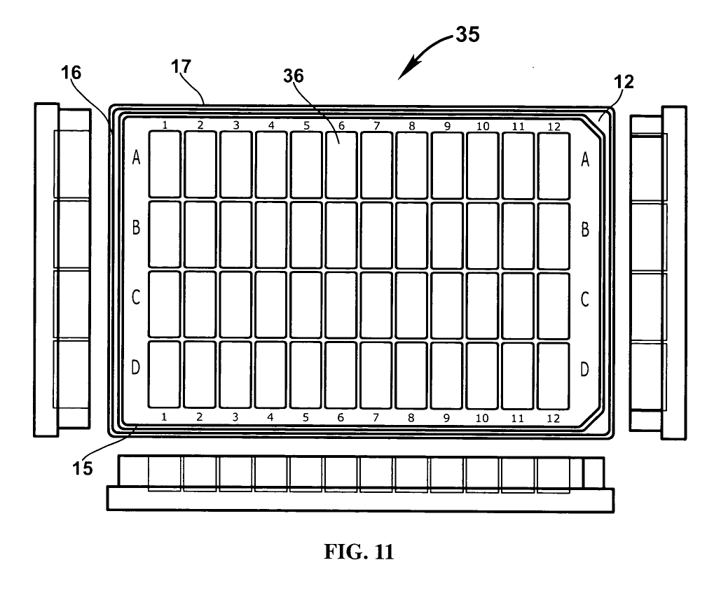

Referring to FIG. 11, another embodiment of the multi-well plate 35 will be described. The test plate 35 includes a base 12, and a plurality of wells 36. The novel design includes 48 wells 36 arranged in a 4×12 matrix, and having a configuration that conforms to the SBC standard for a 96-well plate (same height 15, width 15, and length 17) thereby being compatible with auxiliary equipment, automated instrumentation and robotics available in industry. In this embodiment, the well 36 size is approximately three (3) times larger than the well 14 in the 96-well plate 10.

In another embodiment (not shown) the invention includes a multi-well plate adapted to allow a membrane to be inserted in the well. The membrane may fit snugly across the width of the well or the well may be modified to include grooves to hold the membrane in place. The membrane may be supported be a frame to keep it in shape and position. This embodiment may include a cell culture insert to accommodate more membranes should it be necessary to use more than one membrane.

Each well in this embodiment optionally comprises a sidewall, a bottom surface, and a raised mouth from the upper surface to support the cell culture insert in position.

In an alternative embodiment (not shown), the multi-well plate of the invention is provided with a means for filtration and draining for sample preparation and purification using the multi-well plates of the invention that are configured to maximize the volume of each well while conforming to SBS standards.

While some preferred embodiments of the invention have herein before been described, it will be appreciated that variations of the invention will be perceived by those skilled in the art, which variations are nevertheless within the scope of the invention as defined by the claims appended hereto.

1. A multi-well test plate comprising: a base comprising a four-sided rectangular frame and having the standard configuration of a 96-well plate, said base having a plurality of wells for receiving materials, a cover having a top closure wall, said cover being adapted to be supported in a closed position with the closure wall adjacent the top edges of the wells, wherein each of said wells is rectangular in shape, and has a larger surface area and volume capacity than a 96-well plate well.

2. The multi-well test plate as defined in claim 1, wherein the base comprises a total of 8, 12, 16, 24, 32 or 48 wells.

3. The multi-well test plate as defines in claim 1, wherein the plurality of wells are arranged in a 8×1 matrix of rows by number of wells selected from the group consisting of 8×2, 8×3, 8×4, 8×6, 1×12, 2×12 and 4×12.

4. The multi-well plate as defined in claim 3, wherein the matrix selected is 8×1 and the plate includes 8 wells, each of said wells having a capacity approximately 19 times greater that the 96-well plate well.

5. The multi-well plate as defined in claim 3, wherein the matrix selected is 8×2 and the plate includes 16 wells, each of said wells having a capacity approximately 9 times greater than the 96-well plate well.

6. The multi-well plate as defined in claim 3, wherein the matrix selected is 8×3 and the plate includes 24 wells, each of said wells having a capacity approximately 6 times greater than the 96-well plate well.

7. The multi-well plate as defined in claim 3, wherein the matrix selected is 8×4 and the plate includes 32 wells, each of said wells having a capacity approximately 4 times greater than the 96-well plate well.

8. The multi-well plate as defined in claim 3, wherein the matrix selected is 8×6 and the plate includes 48 wells, each of said wells having a capacity approximately 3 times greater than the 96-well plate well.

9. The multi-well plate as defined in claim 3, wherein the matrix selected is 1×12 and the plate includes 12 wells, each of said wells having a capacity approximately 13 times greater than the 96-well plate well.

10. The multi-well plate as defined in claim 3, wherein the matrix selected is 2×12 and the plate includes 24 wells, each of said wells having a capacity approximately 6 times greater than the 96-well plate well.

11. The multi-well plate as defined in claim 3, wherein the matrix selected is 4×12 and the plate includes 48 wells, each of said wells having a capacity approximately 3 times greater than the 96-well plate well.

12. A multi-well test plate comprising: a base comprising a four-sided rectangular configuration of a 96-well plate,
said base having a plurality of said base having a continuous bottom wall, said wall defining bottom walls for the wells, and
said wells having side walls extending upwardly from said bottom walls to a top surface, the interior of the wells being viewable directly through the well side walls.

13. The multi-well test plate as defined in claim 12, wherein the top surface of the side walls of each well has a raised mouth surface.

14. The multi-well test plate as defined in claim 13, further characterized by a membrane insertable in each well.

15. The multi-well test plate as defined in claim 13, further characterized by a cell culture support insertable in one or more wells.

16. The multi-well test plate as defined in claim 13, further characterizes by means for filtration and purification of a sample.

17. A method for performing tissue culture arrays, the method comprising:
providing a base in the configuration of a 96-well plate and having a plurality of rectangular wells,
growing cells in the rectangular cells in quantities greater than achieved in 96-well plates, and
evaluating the characteristic of the harvested sample using auxiliary equipment available in industry for the 96-well plate standard.

18. The method for performing tissue culture arrays as defined in claim 17, wherein the growth of cells per well is increased by the range of 3 to 12 times that obtained in a 96-well plate well.

19. The method for performing tissue culture arrays as defined in claim 17, wherein the cells are first grown on a membrane, further comprising and inserting a membrane into a well to evaluate transportation or other characteristic of the cells.

20. The method for performing tissue culture arrays as defined in claim 17, further comprising the steps of filtering or purifying the sample using a filtration means.
